(19) United States
(12) Patent Application Publication
(10) Pub. No.: US 2017/0171940 A1
(43) Pub. Date: Jun. 15, 2017

(54) METHOD AND ELECTRONIC DEVICE FOR ADJUSTING BRIGHTNESS ON SCREEN

(71) Applicants: LE HOLDINGS (BEIJING) CO., LTD., Beijing (CN); LEMOBILE INFORMATION TECHNOLOGY (BEIJING) CO., LTD, Beijing (CN)

(72) Inventor: Zihua Feng, Beijing (CN)

(21) Appl. No.: 15/242,370

(22) Filed: Aug. 19, 2016

Related U.S. Application Data
(63) Continuation of application No. PCT/CN2016/089256, filed on Jul. 7, 2016.

(30) Foreign Application Priority Data
Dec. 14, 2015 (CN) 201510927389.9

(51) Int. Cl. H05B 37/02

(52) U.S. Cl. CPC H05B 37/0218

(57) ABSTRACT

The present disclosure provides a method and electronic device for adjusting brightness on screen. The method includes: receiving a brightness adjustment instruction and adjusting a brightness value; combining a new brightness adjustment parameter with a previous brightness adjustment parameter array of a brightness automatic adjustment function constructed previously, to constitute a new brightness adjustment parameter array, wherein the screen brightness value adjusted and a light sensation value of current ambient light are taken as the new brightness adjustment parameter; reconstructing a new brightness automatic adjustment function with the new brightness adjustment parameter array; and automatically adjusting the brightness on screen according to the new brightness automatic adjustment function, when the light sensation value of the current ambient light changes. With the method and electronic device for adjusting brightness on screen according to the disclosure, the brightness can be adjusted automatically according to different user requirements to meet a specific user demand in brightness.

### CROSS-REFERENCE TO RELATED APPLICATIONS

This application is a continuation of International PCT Patent application No. PCT/CN2016/089256, filed Jul. 7, 2016 (attached hereto as Appendix), and claims benefit/priority of Chinese patent application No. 201510927389.9, filed with the State Intellectual Property Office of China on Dec. 14, 2015, which are all incorporated herein by reference in entirety.

### TECHNICAL FIELD

The present disclosure relates to the field of screen control, and in particular, to a method and electronic device for adjusting brightness on screen.

### BACKGROUND

As the intelligent terminal is widely used in people's life, most of the modernists use the intelligent terminal for more than 10 hours in one day. In using the intelligent terminal, ambient light has a great effect on viewing a screen. It is difficult to see clearly the content displayed on the screen when the ambient light is too bright and the screen light is too dark; and an intense stimulation sense is generated to eyes when the ambient light is too dark and the screen light is too bright.

At present, the smart mobile phone on the market generally has a function of automatically adjusting brightness on screen according to the ambient light. However, in using the function of automatically adjusting brightness, a user has to endure an algorithm preset by the manufacturer. For light sensation values (lux) of different ambient light, corresponding brightness values are set for the brightness on screen. Since each of users has different habits and eyesight, for the default screen brightness value, some users may feel that the current brightness is too high or low, and have to turn off the automatic adjusting mode and manually adjust the brightness. However, the manually adjusted brightness is maintained at a specified value. If the ambient light changes, manual adjustment is performed again, or the automatic brightness adjustment mode is turned on again, which is very inconvenient in use.

### SUMMARY

In view of above, an object of the disclosure is to provide a method and electronic device for adjusting brightness on screen, so as to automatically adjust brightness according to different user requirements to meet a brightness requirement of a specific user.

Based on the above objective, according to a first aspect of the disclosure, there is provided a method for adjusting brightness on screen, which includes:

receiving a brightness adjustment instruction and adjusting a screen brightness value;

combining a new brightness adjustment parameter with a previous brightness adjustment parameter array of a brightness automatic adjustment function constructed previously, to constitute a new brightness adjustment parameter array, wherein the screen brightness value adjusted and a light sensation value of current ambient light are taken as the new brightness adjustment parameter;

reconstructing a new brightness automatic adjustment function with the new brightness adjustment parameter array; and

automatically adjusting the brightness on screen according to the new brightness automatic adjustment function, when the light sensation value of the ambient light changes.

According to a second aspect of the present disclosure, there is provided a non-volatile computer storage medium which is stored with computer executable instructions, and the computer executable instructions are configured for performing any one of the above methods for adjusting brightness on screen according to the disclosure.

According to a third aspect of the present disclosure, there is provided an electronic device including one or more processors and a memory, wherein, the memory is stored with instructions executable by the one or more processors, and the instructions are set to perform any one of the above methods for adjusting brightness on screen according to the disclosure.

As can be seen from the foregoing description, with the method and electronic device for adjusting brightness on screen according to the disclosure, the screen brightness value manually adjusted by the user and the light sensation value of the current ambient light are taken as the new brightness adjustment parameter, and the new brightness adjustment parameter is combined with the previous brightness adjustment parameter array to constitute a new brightness adjustment parameter array, which is used to construct a new brightness automatic adjustment function. Therefore, the screen brightness value is adjusted automatically according to the reconstructed brightness automatic adjustment function, when the light sensation value of an ambient light changes next time. Since the automatically adjusted screen brightness value is obtained according to the reconstructed brightness automatic adjustment function, the adjusted screen brightness value can be closer to a user's habit, and the user has no need to readjust the screen brightness value. In this way of adjusting screen brightness, the brightness automatic adjustment function is set by the intelligent terminal used by each user according to the user's habit, sensitivity to light and the like, and the user needs not to use the same brightness automatic adjustment function initially preset in the intelligent terminal. Hence, it is more comfortable for the user to use the intelligent terminal in the new automatic brightness adjustment mode.

It is to be understood that both the foregoing general description and the following detailed description are exemplary and explanatory only, and are not restrictive of the disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for adjusting brightness on screen according to an embodiment of the present disclosure;

FIG. 2 is a flow chart of a method for adjusting brightness on screen according to another embodiment of the present disclosure;

FIG. 3 is a schematic module structural diagram of an device for adjusting brightness on screen according to an embodiment of the present disclosure;

FIG. 4 is a schematic diagram of hardware structure of an electronic device according to an embodiment of the present disclosure.

### DESCRIPTION OF THE EMBODIMENTS

In order to make the objects, technical solutions and advantages of the present disclosure more clear and apparent, the present disclosure is described in details in conjunction with the embodiments and the drawings.

It should be noted that, all descriptions of “first” and “second” used in the embodiment of the disclosure are used to distinguish two different entities or parameters of the same name. It can be seen that the “first” and “second” are merely convenient for expression, and should not be construed as limiting the embodiments of the disclosure, which is not illustrated any more in the following embodiments.

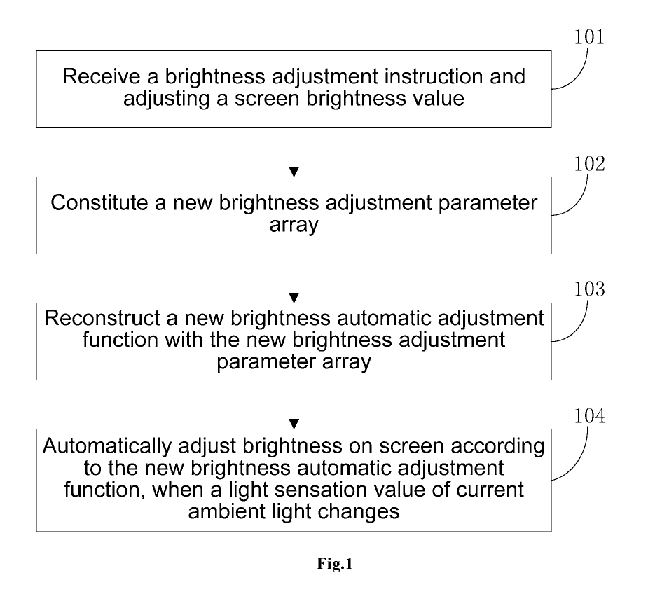

According to a first aspect of the disclosure, there is provided a method for adjusting brightness on screen, with which the brightness can be automatically adjusted according to different user requirements. FIG. 1 is a flow chart of a method for adjusting brightness on screen according to an embodiment of the present disclosure.

The method for adjusting brightness on screen includes the following steps S101 to S104.

In step 101, a brightness adjustment instruction is received and a screen brightness value is adjusted. The brightness adjustment instruction may be issued by the user pressing a brightness adjustment key or by performing a gesture such as a touch and slide on a touch screen, and accordingly a component for receiving the brightness adjustment instruction may be the brightness adjustment key or the touch screen of the intelligent terminal.

In step 102, a new brightness adjustment parameter is combined with a previous brightness adjustment parameter array of a brightness automatic adjustment function constructed previously, to constitute a new brightness adjustment parameter array, wherein the screen brightness value adjusted and a light sensation value of current ambient light are taken as the new brightness adjustment parameter.

The screen brightness value adjusted is a screen brightness value when the user stops an action of adjusting brightness. A way of determining whether the user stops adjusting brightness may include determining whether a new brightness adjustment instruction is received by the component (such as the key, the touch screen and the like) for receiving the brightness adjustment instruction in a preset duration (for example, 2 s to 5 s), and determining that the adjustment is finished, if no new brightness adjustment instruction is received. The light sensation value of the current ambient light may be collected by an element capable of collecting ambient light brightness arranged at an appropriate location in the intelligent terminal or at an appropriate location around the intelligent terminal, such as a light sensor arranged on a smart phone.

In step 103, a new brightness automatic adjustment function is reconstructed with the new brightness adjustment parameter array.

In step 104, the brightness on screen is adjusted automatically according to the new brightness automatic adjustment function, when the light sensation value of the current ambient light changes.

As can be seen from the foregoing embodiment, with the method for adjusting brightness on screen according to the disclosure, the screen brightness value manually adjusted by the user and the light sensation value of the current ambient light are taken as the new brightness adjustment parameter, and the new brightness adjustment parameter is combined with the previous brightness adjustment parameter array to constitute a new brightness adjustment parameter array, which is used to construct a new brightness automatic adjustment function. Therefore, the screen brightness value is adjusted automatically according to the reconstructed brightness automatic adjustment function, when the light sensation value of ambient light changes next time. Since the automatically adjusted screen brightness value is obtained according to the reconstructed brightness automatic adjustment function, the adjusted screen brightness value can be closer to a user's habit, and the user has no need to readjust the screen brightness value. In this way of adjusting brightness on screen, a brightness automatic adjustment function is set by the intelligent terminal used by each user according to the user's habit, sensitivity to light and the like, and the user needs not to use the same brightness automatic adjustment function initially preset in the intelligent terminal. Hence, it is more comfortable for the user to use the intelligent terminal in the new automatic brightness adjustment mode.

Optionally, before the step 101 of receiving a brightness adjustment instruction and adjusting a screen brightness value, the method may further include a step of starting up. That is, at an initial state, the intelligent terminal first acquires the light sensation value of the current ambient light and automatically adjusts the screen brightness value according to an initial brightness automatic adjustment function. At this time, if the user thinks that an initial automatically adjusted screen brightness value obtained according to the brightness automatic adjustment function is not suitable for his/her own use, the user may start to manually adjust the brightness.

For a general intelligent terminal, especially a mobile phone, the correspondence between the light sensation value and the screen brightness value in the brightness adjustment parameter is preset at the factory, a maximum value and a minimum value are specified, and an initial brightness adjustment parameter array, for example, {[0,0], [100, 10], [300, 20], [1000,150], [9999, 256]}, composed of a set of brightness adjustment parameters is formed according to the screen parameters. The initial brightness adjustment parameter array includes 5 brightness adjustment parameters, where the former number represents the light sensation value, and the later number represents the screen brightness value. In the above embodiment, if the intelligent terminal is used for the first time, the previous brightness adjustment parameter array and the previous brightness automatic adjustment function are the initial brightness adjustment parameter array and the initial brightness automatic adjustment function, respectively.

After the screen brightness value is manually adjusted by the user, a new brightness adjustment parameter is obtained, for example, [500,120]. When a new brightness adjustment parameter array is to constructed, the new brightness adjustment parameter may be added into an appropriate location in the previous brightness adjustment parameter array, to constitute the new brightness adjustment parameter array: {[0,0], [100,10], [300,20], [500,120], [1000,150], [9999,256]}. A brightness automatic adjustment function may be reconstructed according to the new brightness adjustment parameter array.

When a new brightness automatic adjustment function is reconstructed completely, it is saved and an extraction path of a brightness automatic adjustment function in a system service layer is modified. In this way, the new brightness automatic adjustment function can be used in automatically adjusting brightness next time. Furthermore, with the method according to the above embodiment, when the screen brightness value is manually adjusted next time, the brightness automatic adjustment function can be reconstructed again according to the adjusted screen brightness value.

Optionally, the brightness automatic adjustment function may be constructed by using an sp line function.

The spline function is a function which includes smooth sections (pieces) and has smoothness at junctions of sections, that is, a spline function. The term “spline” is derived from a tool for joining some specified points into a smooth curve used by the engineering drafting personnel, that is, a flexible thin wood strip or thin steel strip. The curve formed by such an spline has continuous slope and curvature at the junctions. A piecewise low-order polynomial having a function interpolation with a certain smoothness at sections is developed by simulating the above principle, which overcomes the oscillation that may occur in a high-order polynomial interpolation, and has good numerical stability and convergence. A function generated by the interpolation process is a polynomial spline function.

A method for constructing the sp line function may be accomplished according to the prior art, which is not repeated any more herein.

Furthermore, in some embodiments, after the step 101 of receiving a brightness adjustment instruction and adjusting a screen brightness value, the method further includes the following steps.

It is determined whether the screen brightness value adjusted exceeds a first preset range of screen brightness values associated with the light sensation value of the current ambient light. Here, the first preset range of screen brightness values is predetermined, and a reasonable adjustment range of one screen brightness value set with respect to each light sensation value. All screen brightness values in the first preset range of screen brightness values are regarded as better screen brightness values under the light sensation value of the current ambient light, which may be determined based on considerations of eyesight protection or screen display effect.

If the screen brightness value adjusted does not exceed the first preset range of screen brightness values, which represents that the screen brightness value adjusted is reasonable, the screen brightness value adjusted is maintained.

If the screen brightness value adjusted exceeds the first preset range of screen brightness values, which represents that the screen brightness value adjusted is unreasonable, a prompt that the screen brightness value adjusted exceeds the first preset range of screen brightness values is issued to prompt the user that the screen brightness value exceeds a reasonable range, and a prompt whether the brightness value is changed may be issued, then it is determined whether an instruction of changing the brightness value is received.

If the instruction of changing a brightness value is received, which represents that the user deems that the screen brightness value is indeed a screen brightness value the user wanted to adjust, the screen brightness value adjusted is maintained.

Through the designing in the above-described embodiment, when the screen brightness value is adjusted by the user to an unreasonable range, a prompt that the screen brightness value is unreasonable is issued for the user, which plays a role of warning, and is also based on considerations of eyesight or experience of the user. If the user insists on using the screen brightness value, the wish of the user is respected, and the screen brightness value is used as the screen brightness value that the user wants to use.

Based on the above embodiment, after the step of determining whether an instruction of changing a brightness value is received, the method further includes:

returning to and maintaining the previous automatic adjusted screen brightness value, if an instruction of not changing a brightness value is received, which represents that the user does not want to use an unreasonable screen brightness value deemed by the system; or

preferably, adjusting the screen brightness value to be a maximum value in the first preset range of screen brightness values, if the instruction of not changing a brightness value is received and the screen brightness value adjusted is greater than the maximum value in the first preset range of screen brightness values (which represents that the user wants to lighten the screen brightness);

adjusting the screen brightness value to be a minimum value in the first preset range of screen brightness values, if the instruction of not changing a brightness value is received and the screen brightness value adjusted is less than the minimum value in the first preset range of screen brightness values (which represents that the user wants to darken the screen brightness).

Through the designing in the above-described embodiment, when the screen brightness value is adjusted by the user to the unreasonable range and the user decides to not use the unreasonable screen brightness value after being promoted, it may be returned to the previous automatic adjusted screen brightness value and it is maintained. Preferably, for a better use effect, the screen brightness value may be adjusted to an endpoint value of the first preset range of screen brightness values. Therefore, the effect of adjusting the screen brightness value is achieved, and it is ensured that the screen brightness value is in the reasonable range.

Since the unreasonable screen brightness value or larger or smaller screen brightness values may occur in adjusting the screen brightness value by the user, the following unreasonable cases may occur in a brightness adjustment parameter array constituted by a new brightness adjustment parameter: a screen brightness value of a brightness adjustment parameter, of which a light sensation value is less than that of a new brightness adjustment parameter, is greater than the screen brightness value of the new brightness adjustment parameter; or a screen brightness value of a brightness adjustment parameter, of which a light sensation value is greater than that of the new brightness adjustment parameter, is less than the screen brightness value of the new brightness adjustment parameter. The cases may cause that the screen brightness value goes up and down when an automatic adjustment is performed using a new brightness automatic adjustment function.

Therefore, based on the above embodiments, before the step 102 of constituting a new brightness adjustment parameter array, the method further includes:

determining whether the screen brightness value adjusted is less than a screen brightness value corresponding to an initial brightness adjustment parameter, of which a light sensation value is less than the light sensation value of the current ambient light in the previous brightness adjustment parameter array;

modifying screen brightness values corresponding to all of previous brightness adjustment parameters, of which light sensation values are less than the light sensation value of the current ambient light and screen brightness values are greater than the screen brightness value adjusted in the previous brightness adjustment parameter array, to be the screen brightness value adjusted, if the screen brightness value adjusted is less than the screen brightness value corresponding to the initial brightness adjustment parameter;

directly adding the screen brightness value adjusted and the light sensation value of the current ambient light as the new brightness adjustment parameter into the previous brightness adjustment parameter array, to constitute the new brightness adjustment parameter array, if the screen brightness value adjusted is not less than the screen brightness value corresponding to the initial brightness adjustment parameter; and/or

determining whether the screen brightness value adjusted is greater than a screen brightness value corresponding to a previous brightness adjustment parameter, of which a light sensation value is greater than the light sensation value of the current ambient light in the previous brightness adjustment parameter array;

modifying screen brightness values corresponding to all of previous brightness adjustment parameters, of which light sensation values are greater than the light sensation value of the current ambient light and screen brightness values are less than the screen brightness value adjusted in the previous brightness adjustment parameter array, to be the screen brightness value adjusted, if the screen brightness value adjusted is greater than the screen brightness value corresponding to the previous brightness adjustment parameter;

directly adding the screen brightness value adjusted and the light sensation value of the current ambient light as the new brightness adjustment parameter into the previous brightness adjustment parameter array, to constitute the new brightness adjustment parameter array, if the screen brightness value adjusted is not greater than the screen brightness value corresponding to the previous brightness adjustment parameter.

With the above method, the new brightness adjustment parameter defined or defaulted reasonably by the user is used as a standard, the screen brightness values in other previous brightness adjustment parameters which are in conflict with the new brightness adjustment parameter are adjusted to be identical, thereby eliminating the problem that the screen brightness value goes up and down when automatic adjustment is performed using a new brightness automatic adjustment function.

In addition, in an embodiment parallel with the above embodiment, before the step 102 of constituting a new brightness adjustment parameter array, the method further includes the following steps.

It is determined whether the screen brightness value adjusted exceeds a second preset range of screen brightness values associated with the light sensation value of the current ambient light. The second preset range of screen brightness values may be the same as the first preset range of screen brightness values, and the setting way and basis may also refer to the setting of the first preset range of screen brightness values. If the second preset range of screen brightness values is different from the first preset range of screen brightness values, the second preset range of screen brightness values may be set with reference to other basis. For example, the screen brightness values of the brightness adjustment parameters arranged before and after the new brightness adjustment parameter (that is, the brightness adjustment parameter of which the light sensation value is less than and closest to the light sensation value of the new brightness adjustment parameter, and the brightness adjustment parameter of which the light sensation value is greater than and closest to the light sensation value of the new brightness adjustment parameter) are used as two endpoints of the second preset range of screen brightness values.

It is determined that the screen brightness value adjusted is pseudo data (i.e., unreasonable data), the screen brightness value adjusted is excluded from the new brightness adjustment parameter array, and it is returned to the previous automatic adjusted screen brightness value and it is maintained, if the screen brightness value adjusted exceeds the second preset range of screen brightness values.

The screen brightness value adjusted and the light sensation value of current ambient light as the new brightness adjustment parameter directly are added into the previous brightness adjustment parameter array, to constitute the new brightness adjustment parameter array, if the screen brightness value adjusted does not exceed the second preset range of screen brightness values.

In the above embodiment, unreasonable data is excluded directly with a simple method, thereby ensuring the rationality of the new brightness automatic adjustment function.

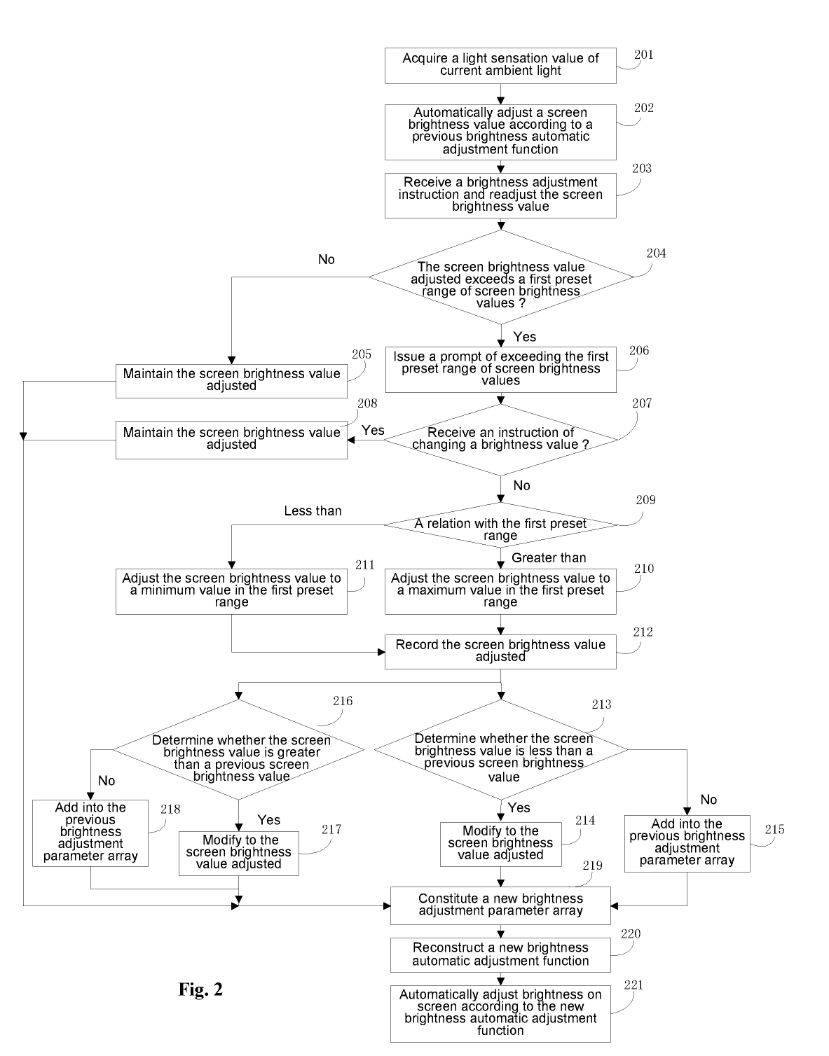

FIG. 2 is a flow chart of a method for adjusting brightness on screen according to another embodiment of the present disclosure.

The method for adjusting brightness on screen includes steps 201-221.

In step 201, a light sensation value of current ambient light is acquired.

In step 202, a screen brightness value is automatically adjusted according to a previous brightness automatic adjustment function.

In step 203, a brightness adjustment instruction is received and the screen brightness value is readjusted.

In step 204, it is determined whether the screen brightness value adjusted exceeds a first preset range of screen brightness values associated with the light sensation value of the current ambient light.

In step 205, the screen brightness value adjusted is maintained, if the screen brightness value adjusted does not exceed a first preset range of screen brightness values.

In step 206, a prompt that the screen brightness value adjusted exceeds the first preset range of screen brightness values is issued, if the screen brightness value adjusted exceeds a first preset range of screen brightness values.

In step 207, it is determined whether an instruction of changing a brightness value is received.

In step 208, the screen brightness value adjusted is maintained, if the instruction of changing a brightness value is received.

In step 209, a relation between the screen brightness value adjusted and the first preset range of screen brightness values is determined, if an instruction of not changing a brightness value is received.

In step 210, the screen brightness value is adjusted to be a maximum value in the first preset range of screen brightness values, if the screen brightness value adjusted is greater than the maximum value in the first preset range of screen brightness values.

In step 211, the screen brightness value is adjusted to be a minimum value in the first preset range of screen brightness values, if the screen brightness value adjusted is less than the minimum value in the first preset range of screen brightness values.

In step 212, the screen brightness value adjusted is recorded.

In step 213, it is determined whether the screen brightness value adjusted is less than a screen brightness value corresponding to a previous brightness adjustment parameter, of which a light sensation value is less than the light sensation value of the current ambient light in the previous brightness adjustment parameter array.

In step 214, screen brightness values corresponding to all of previous brightness adjustment parameters, of which light sensation values are less than the light sensation value of the current ambient light and screen brightness values are greater than the screen brightness value adjusted in the previous brightness adjustment parameter array, are modified to be the screen brightness value adjusted, if the screen brightness value adjusted is less than the screen brightness value corresponding to the previous brightness adjustment parameter.

In step 215, the screen brightness value adjusted and the light sensation value of the current ambient light as a new brightness adjustment parameter are directly added into the previous brightness adjustment parameter array, to constitute the new brightness adjustment parameter array, if the screen brightness value adjusted is not less than the screen brightness value corresponding to the previous brightness adjustment parameter.

In step 216, it is determined whether the screen brightness value adjusted is greater than a screen brightness value corresponding to a previous brightness adjustment parameter, of which a light sensation value is greater than the light sensation value of the current ambient light in the previous brightness adjustment parameter array.

In step 217, screen brightness values corresponding to all of previous brightness adjustment parameters, of which light sensation values are greater than the light sensation value of the current ambient light and screen brightness values are less than the screen brightness value adjusted in the previous brightness adjustment parameter array, are modified to be the screen brightness value adjusted, if the screen brightness value adjusted is greater than the screen brightness value corresponding to the previous brightness adjustment parameter.

In step 218, the screen brightness value adjusted and the light sensation value of the current ambient light as the new brightness adjustment parameter are directly added into the previous brightness adjustment parameter array, to constitute the new brightness adjustment parameter array, if the screen brightness value adjusted is not greater than the screen brightness value corresponding to the previous brightness adjustment parameter.

In step 219, the new brightness adjustment parameter is combined with the previous brightness adjustment parameter array of a brightness automatic adjustment function constructed previously, to constitute the new brightness adjustment parameter array, wherein the screen brightness value adjusted and a light sensation value of current ambient light are taken as the new brightness adjustment parameter;

In step 220, a new brightness automatic adjustment function is reconstructed with the new brightness adjustment parameter array.

In step 221, the brightness on screen is automatically adjusted according to the new brightness automatic adjustment function, when the light sensation value of the ambient light changes.

As can be seen from the foregoing embodiment, with the method for adjusting brightness on screen according to the disclosure, the screen brightness value manually adjusted by the user and the light sensation value of the current ambient light are taken as the new brightness adjustment parameter, and the new brightness adjustment parameter is combined with the previous brightness adjustment parameter array to constitute a new brightness adjustment parameter array, which is used to construct a new brightness automatic adjustment function. Therefore, the screen brightness value is adjusted automatically according to the reconstructed brightness automatic adjustment function, when the light sensation value of ambient light changes next time. Since the automatically adjusted screen brightness value is obtained according to the reconstructed brightness automatic adjustment function, the adjusted screen brightness value can be closer to the user's habit, and the user has no need to readjust the screen brightness value. In this way of adjusting brightness on screen, a brightness automatic adjustment function is set by the intelligent terminal used by each user according to the user's habit, sensitivity to light, and the user needs not to use the same brightness automatic adjustment function initially preset in the intelligent terminal. Hence, it is more comfortable for the user to use the intelligent terminal in the new automatic brightness adjustment mode. Furthermore, a determination and prompt of an unreasonable screen brightness value is further added, and the parameter is reconfigured and readjusted according to the user requirement, such that the finally obtained brightness automatic adjustment function can better meet the user requirement.

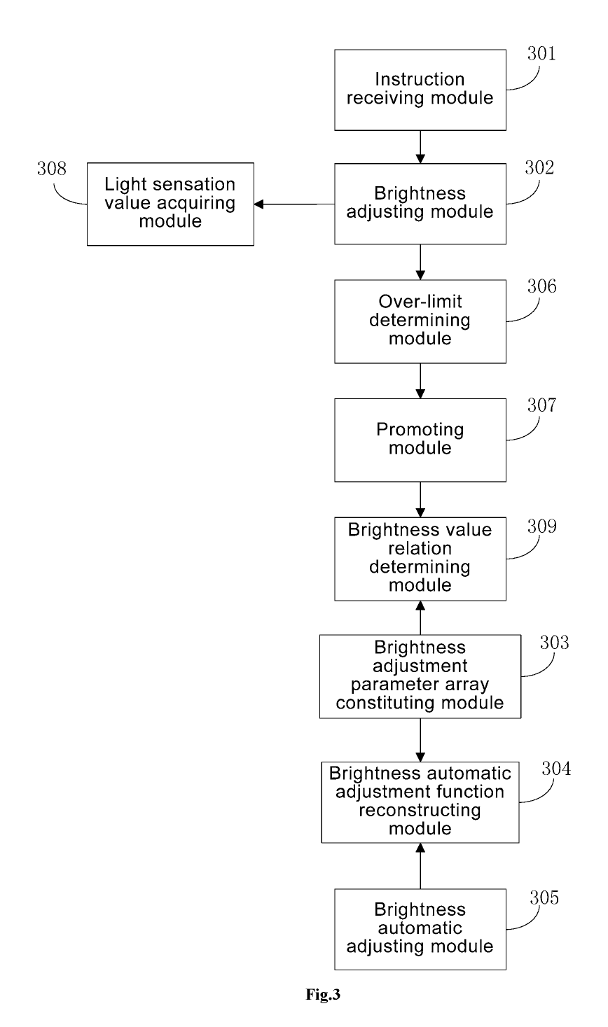

In a second aspect, a device for adjusting brightness on screen is provided according to the disclosure. FIG. 3 is a schematic module structural diagram of a device for adjusting brightness on screen according to an embodiment of the present disclosure.

The device for adjusting brightness on screen includes: an instruction receiving module 301, a brightness adjusting module 302, a brightness adjustment parameter array constituting module 303, a brightness automatic adjustment function reconstructing module 304 and a brightness automatic adjusting module 305.

The instruction receiving module 301 is configured for receiving a brightness adjustment instruction. The brightness adjustment instruction may be issued by the user pressing a brightness adjustment key or by performing a gesture such as a touch and slide on a touch screen. Accordingly, the instruction receiving module 301 may be the brightness adjustment key or the touch screen of the intelligent terminal, other peripheral configuration circuits and the like.

The brightness adjusting module 302 is configured for adjusting a screen brightness value according to the brightness adjustment instruction.

The brightness adjustment parameter array constituting module 303 is configured for combining a new brightness adjustment parameter with a previous brightness adjustment parameter array of a brightness automatic adjustment function constructed previously, to constitute a new brightness adjustment parameter array, wherein the screen brightness value adjusted and a light sensation value of current ambient light are taken as the new brightness adjustment parameter.

The screen brightness value adjusted is a screen brightness value when the user stops an action of adjusting brightness. A way of determining whether the user stops adjusting brightness may include determining whether a new brightness adjustment instruction is received by the component (such as the key, the touch screen) for receiving the brightness adjustment instruction in a preset duration (for example, 2 s to 5 s), and determining that the adjustment is finished, if no new brightness adjustment instruction is received. The light sensation value of the current ambient light may be collected by an element capable of collecting ambient light brightness arranged at an appropriate location in the intelligent terminal or at an appropriate location around the intelligent terminal, such as a light sensor arranged on the smart phone.

The brightness automatic adjustment function reconstructing module 304 is configured for reconstructing a new brightness automatic adjustment function with the new brightness adjustment parameter array.

The brightness automatic adjusting module 305 is configured for automatically adjusting the brightness on screen according to the new brightness automatic adjustment function, when the light sensation value of the ambient light changes.

As can be seen from the foregoing embodiment, with the device for adjusting brightness on screen according to the disclosure, the screen brightness value manually adjusted by the user and the light sensation value of current ambient light are taken as the new brightness adjustment parameter, and the new brightness adjustment parameter is combined with the previous brightness adjustment parameter array to constitute a new brightness adjustment parameter array, which is used to construct a new brightness automatic adjustment function. Therefore, the screen brightness value is adjusted automatically according to the reconstructed brightness automatic adjustment function, when the light sensation value of ambient light changes next time. Since the automatically adjusted screen brightness value is obtained according to the reconstructed brightness automatic adjustment function, the adjusted screen brightness value can be closer to the user's habit, and the user has no need to readjust the screen brightness value. In this way of adjusting brightness on screen, a brightness automatic adjustment function is set by the intelligent terminal used by a user according to the user's habit, sensitivity to light, and the user needs not to use the same brightness automatic adjustment function initially preset in the intelligent terminal. Hence, it is more comfortable for the user to use the intelligent terminal in the new automatic brightness adjustment mode.

Furthermore, in some embodiments, the device further includes: an over-limit determining module 306 and a promoting module 307.

The over-limit determining module 306 is configured for determining whether the screen brightness value adjusted exceeds a first preset range of screen brightness values associated with the light sensation value of the current ambient light. Here, the first preset range of screen brightness values is determined previously, and a reasonable adjustment range of one screen brightness value which is set with respect to each light sensation value. All screen brightness values in the first preset range of screen brightness values are regarded as better screen brightness values under the light sensation value of the current ambient light, which are determined based on consideration of eyesight protection or screen display effect.

If the screen brightness value adjusted does not exceed the first preset range of screen brightness values, which represents that the screen brightness value adjusted is reasonable, the brightness adjusting module 302 is further configured for maintaining the screen brightness value adjusted.

If the screen brightness value adjusted exceeds the first preset range of screen brightness values, which represents that the screen brightness value adjusted is unreasonable, the promoting module 307 is configured for issuing a prompt that the screen brightness value adjusted exceeds the first preset range of screen brightness values, and the instruction receiving module 301 is further configured for determining whether an instruction of changing a brightness value is received.

If the instruction of changing a brightness value is received, which represents that the user deems that the screen brightness value is indeed the screen brightness value the user wanted to adjust, the brightness adjusting module 302 is further configured for maintaining the screen brightness value adjusted.

Through the designing in the above-described embodiment, when the screen brightness value is adjusted by the user to an unreasonable range, a prompt that the screen brightness value is unreasonable is issued for the user, which plays a role of warning, and is based on consideration of eyesight or experience of the user. If the user insists on using the screen brightness value, the wish of the user is respected, and the screen brightness value is used as the screen brightness value that the user wants to use.

Based on the above embodiment, the brightness adjusting module 302 is further configured for returning to and maintaining the previous automatic adjusted screen brightness value, if an instruction of not changing a brightness value is received by the instruction receiving module 301, which represents that the user does not want to use the unreasonable screen brightness value deemed by the system.

Or, preferably, the brightness adjusting module 302 is further configured for adjusting the screen brightness value to be a maximum value in the first preset range of screen brightness values, if the instruction of not changing a brightness value is received by the instruction receiving module 301 and the screen brightness value adjusted is greater than the maximum value in the first preset range of screen brightness values (which represents that the user wants to lighten the screen brightness).

The brightness adjusting module 302 is further configured for adjusting the screen brightness value to be a minimum value in the first preset range of screen brightness values, if the instruction of not changing a brightness value is received by instruction receiving module 301 and the screen brightness value adjusted is less than the minimum value in the first preset range of screen brightness values (which represents that the user wants to darken the screen brightness).

Through the designing in the above-described embodiment, when the screen brightness value is adjusted by the user to the unreasonable range and the user decides to not use the unreasonable screen brightness value after being promoted, it may be returned to the previous automatic adjusted screen brightness value and it is maintained. Preferably, for a better use effect, the screen brightness value may be adjusted to be an endpoint value of the first preset range of screen brightness values. Therefore, the effect of adjusting the screen brightness value is achieved, and it is ensured that the screen brightness value is in the reasonable range.

Since the unreasonable screen brightness value or too larger or smaller screen brightness values may occur in adjusting the screen brightness value by the user, the following unreasonable cases may occur in the brightness adjustment parameter array constituted with a new brightness adjustment parameter: a screen brightness value of the brightness adjustment parameter, of which a light sensation value is less than that of the new brightness adjustment parameter, is greater than the screen brightness value of the new brightness adjustment parameter; or the screen brightness value of the brightness adjustment parameter, of which the light sensation value is greater than that of the new brightness adjustment parameter, is less than the screen brightness value of the new brightness adjustment parameter. The cases may cause that the screen brightness value goes up and down when automatic adjustment is performed using a new brightness automatic adjustment function.

Based on the above embodiments, the brightness adjustment parameter array constituting module 303 is further configured for:

determining whether the screen brightness value adjusted is less than a screen brightness value corresponding to a previous brightness adjustment parameter, of which a light sensation value is less than the light sensation value of the current ambient light in the previous brightness adjustment parameter array;

modifying screen brightness values corresponding to all of previous brightness adjustment parameters, of which light sensation values are less than the light sensation value of the current ambient light and screen brightness values are greater than the screen brightness value adjusted in the previous brightness adjustment parameter array, to be the screen brightness value adjusted, if the screen brightness value adjusted is less than the screen brightness value corresponding to the previous brightness adjustment parameter;

directly adding the screen brightness value adjusted and the light sensation value of the current ambient light as the new brightness adjustment parameter into the previous brightness adjustment parameter array, to constitute the new brightness adjustment parameter array, if the screen brightness value adjusted is not less than the screen brightness value corresponding to the previous brightness adjustment parameter; and/or

determining whether the screen brightness value adjusted is greater than a screen brightness value corresponding to a previous brightness adjustment parameter, of which a light sensation value is greater than the light sensation value of the current ambient light in the previous brightness adjustment parameter array;

modifying screen brightness values corresponding to all of previous brightness adjustment parameters, of which light sensation values are greater than the light sensation value of the current ambient light and screen brightness values are less than the screen brightness value adjusted in the previous brightness adjustment parameter array, to be the screen brightness value adjusted, if the screen brightness value adjusted is greater than the screen brightness value corresponding to the previous brightness adjustment parameter;

directly adding the screen brightness value adjusted and the light sensation value of the current ambient light as the new brightness adjustment parameter into the previous brightness adjustment parameter array, to constitute the new brightness adjustment parameter array, if the screen brightness value adjusted is not greater than the screen brightness value corresponding to the previous brightness adjustment parameter.

With the above method, the new brightness adjustment parameter defined or defaulted reasonably by the user is used as the standard, and the screen brightness values in other previous brightness adjustment parameters which are in conflict with the new brightness adjustment parameter are adjusted to be identical, thereby eliminating the problem that the screen brightness value goes up and down when automatic adjustment is performed using a new brightness automatic adjustment function.

In addition, in an embodiment parallel with the above embodiment, the device further includes: an over-limit determining module 306, configured for determining whether the screen brightness value adjusted exceeds a second preset range of screen brightness values associated with the light sensation value of the current ambient light. The second preset range of screen brightness values may be the same as the first preset range of screen brightness values, and the setting way and basis may also refer to the setting of the first preset range of screen brightness values. If the second preset range of screen brightness values is different from the first preset range of screen brightness values, the second preset range of screen brightness values may be set with reference to other basis. For example, the screen brightness values of the brightness adjustment parameters arranged before and after the new brightness adjustment parameter (that is, the brightness adjustment parameter of which the light sensation value is less than and closest to the light sensation value of the new brightness adjustment parameter, and the brightness adjustment parameter of which the light sensation value is greater than and closest to the light sensation value of the new brightness adjustment parameter) are used as two endpoints of the second preset range of screen brightness values.

If the screen brightness value adjusted exceeds the second preset range of screen brightness values, the brightness adjustment parameter array constituting module 303 is further configured for determining that the screen brightness value adjusted is pseudo data (that is, unreasonable data), and excluding the screen brightness value adjusted from the new brightness adjustment parameter array, and the brightness adjusting module 302 is further configured for returning to and maintaining the previous automatic adjusted screen brightness value.

If the screen brightness value adjusted does not exceed the second preset range of screen brightness values, the brightness adjustment parameter array constituting module 303 is further configured for directly adding the screen brightness value adjusted and the light sensation value of the current ambient light as the new brightness adjustment parameter into the previous brightness adjustment parameter array, to constitute the new brightness adjustment parameter array.

In the above embodiment, the unreasonable data is excluded directly with a simple method, thereby ensuring the rationality of the new brightness automatic adjustment function.

It is illustrated how to apply the device for adjusting brightness on screen according to the disclosure to the method for adjusting brightness on screen below with reference to FIG. 2.

The method for adjusting brightness on screen includes steps 201-221.

In step 201, a light sensation value acquiring module 308 acquires a light sensation value of current ambient light.

In step 202, the brightness adjusting module 302 automatically adjusts a screen brightness value according to a previous brightness automatic adjustment function.

In step 203, the instruction receiving module 301 receives a brightness adjustment instruction and the brightness adjusting module 302 readjusts a screen brightness value.

In step 204, the over-limit determining module 306 determines whether the screen brightness value adjusted exceeds a first preset range of screen brightness values associated with the light sensation value of the current ambient light.

In step 205, the brightness adjusting module 302 maintains the screen brightness value adjusted, if the screen brightness value adjusted does not exceed the first preset range of screen brightness values.

In step 206, the promoting module 307 issues a prompt that the screen brightness value adjusted exceeds the first preset range of screen brightness values, if the screen brightness value adjusted exceeds the first preset range of screen brightness values.

In step 207, the instruction receiving module 301 determines whether an instruction of changing a brightness value is received.

In step 208, the brightness adjusting module 302 maintains the screen brightness value adjusted, if the instruction of changing a brightness value is received.

In step 209, a brightness value relation determining module 309 determines a relation between the screen brightness value adjusted and the first preset range of screen brightness values, if an instruction of not changing a brightness value is received.

In step 210, the brightness adjusting module 302 adjusts the screen brightness value to be a maximum value in the first preset range of screen brightness values, if the screen brightness value adjusted is greater than the maximum value in the first preset range of screen brightness values.

In step 211, the brightness adjusting module 302 adjusts the screen brightness value to be a minimum value in the first preset range of screen brightness values, if the screen brightness value adjusted is less than the minimum value in the first preset range of screen brightness values.

In step 212, the brightness adjustment parameter array constituting module 303 records the screen brightness value adjusted.

In step 213, the brightness adjustment parameter array constituting module 303 determines whether the screen brightness value adjusted is less than a screen brightness value corresponding to a previous brightness adjustment parameter, of which a light sensation value is less than the light sensation value of the current ambient light in the previous brightness adjustment parameter array.

In step 214, the brightness adjustment parameter array constituting module 303 modifies screen brightness values corresponding to all of previous brightness adjustment parameters, of which light sensation values are less than the light sensation value of the current ambient light and screen brightness values are greater than the screen brightness value adjusted in the previous brightness adjustment parameter array, to be the screen brightness value adjusted, if the screen brightness value adjusted is less than the screen brightness value corresponding to the previous brightness adjustment parameter.

In step 215, the brightness adjustment parameter array constituting module 303 directly adds the screen brightness value adjusted and the light sensation value of the current ambient light as a new brightness adjustment parameter into the previous brightness adjustment parameter array, to constitute the new brightness adjustment parameter array, if the screen brightness value adjusted is not less than the screen brightness value corresponding to the previous brightness adjustment parameter.

In step 216, the brightness adjustment parameter array constituting module 303 determines whether the screen brightness value adjusted is greater than a screen brightness value corresponding to a previous brightness adjustment parameter, of which a light sensation value is greater than the light sensation value of the current ambient light in the previous brightness adjustment parameter array.

In step 217, the brightness adjustment parameter array constituting module 303 modifies screen brightness values corresponding to all of previous brightness adjustment parameters, of which light sensation values are greater than the light sensation value of the current ambient light and screen brightness values are less than the screen brightness value adjusted in the previous brightness adjustment parameter array, to be the screen brightness value adjusted, if the screen brightness value adjusted is greater than the screen brightness value corresponding to the previous brightness adjustment parameter.

In step 218, the brightness adjustment parameter array constituting module 303 directly adds the screen brightness value adjusted and the light sensation value of the current ambient light as the new brightness adjustment parameter into the previous brightness adjustment parameter array, to constitute the new brightness adjustment parameter array, if the screen brightness value adjusted is not greater than the screen brightness value corresponding to the previous brightness adjustment parameter.

In step 219, the brightness adjustment parameter array constituting module 303 combines the new brightness adjustment parameter with the previous brightness adjustment parameter array of a brightness automatic adjustment function constructed previously, to constitute a new brightness adjustment parameter array, wherein the screen brightness value adjusted and a light sensation value of current ambient light are taken as the new brightness adjustment parameter.

In step 220, the brightness automatic adjustment function reconstructing module 304 reconstructs a new brightness automatic adjustment function with the new brightness adjustment parameter array.

In step 221, the brightness automatic adjusting module 305 automatically adjusts brightness on screen according to the new brightness automatic adjustment function, when the light sensation value of the current ambient light changes.

As can be seen from the foregoing embodiment, with the method for adjusting brightness on screen according to the disclosure, the screen brightness value manually adjusted by the user and the light sensation value of current ambient light are taken as the new brightness adjustment parameter, and the new brightness adjustment parameter is combined with the previous brightness adjustment parameter array to constitute a new brightness adjustment parameter array, which is used to construct a new brightness automatic adjustment function. Therefore, the screen brightness value is adjusted automatically according to the reconstructed brightness automatic adjustment function, when the light sensation value of ambient light changes next time. Since the automatically adjusted screen brightness value is obtained according to the reconstructed brightness automatic adjustment function, the adjusted screen brightness value can be closer to the user's habit, and the user has no need to readjust the screen brightness value. In this way of adjusting brightness on screen, a brightness automatic adjustment function is set by the intelligent terminal used by each user according to the user's habit, sensitivity to light, and the user needs not to use the same brightness automatic adjustment function initially preset in the intelligent terminal. Hence, it is more comfortable for the user to use the intelligent terminal in the new automatic brightness adjustment mode. In addition, the determination and prompt for an unreasonable screen brightness value is further added, the parameter is reconfigured and readjusted according to the user requirement, so that the finally obtained brightness automatic adjustment function can meet the user requirement better.

According to an embodiment of the present disclosure, there is provided a non-volatile computer storage medium, which is stored with computer executable instructions, and the computer executable instructions are configured for performing the method for adjusting brightness on screen in any embodiments.

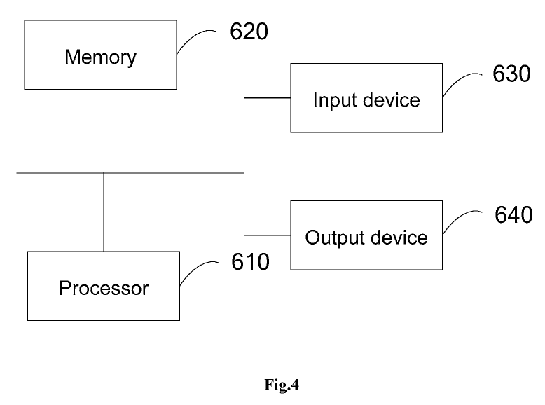

FIG. 4 is a schematic diagram of hardware structure of an electronic device used to perform the method for adjusting brightness on screen according to an embodiment of the present disclosure, as shown in FIG. 4, the device includes:

One or more processors 610 and a memory 620, FIG. 4 illustrates one processor 610 as an example.

The device for the method for adjusting brightness on screen may further include an input device 630 and an output device 640.

The processor 610, the memory 620, the input device 630 and the output device 640 may be connected with each other through bus or other forms of connections. FIG. 4 illustrates bus connection as an example.

As a non-volatile computer-readable storage medium, the memory 620 may be configured to store non-volatile software program, non-volatile computer executable program and modules. By executing the non-volatile software program, instructions and modules stored in the memory 620, the processor 610 may perform various functional applications of the server and data processing, that is, the method for adjusting brightness on screen according to the above mentioned embodiments.

The memory 620 may include a program storage area and a data storage area, wherein, the program storage area may be stored with the operating system and applications which are needed by at least one functions, and the data storage area may be stored with data which is created according to use of the device for adjusting brightness on screen. Further, the memory 620 may include a high-speed random access memory, and may further include non-volatile memory, such as at least one of disk memory device, flash memory device or other types of non-volatile solid state memory device. In some embodiments, optionally, the memory 620 may include memory provided remotely from the processor 610, and such remote memory may be connected with the device for adjusting brightness on screen through network connections, the examples of the network connections may include but not limited to internet, intranet, LAN (Local Area Network), mobile communication network or combinations thereof.

The input device 630 may receive inputted number or character information, and generate key signal input related to the user settings and functional control of the device for adjusting brightness on screen. The output device 640 may include a display device such as a display screen.

The above one or more modules may be stored in the memory 620, when these modules are executed by the one or more processors 610, the method for adjusting brightness on screen according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smarttoys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

1. A method for adjusting brightness on screen, which is applied to a terminal, comprising:
receiving an instruction of adjusting brightness and adjusting a screen brightness value;
combining a new brightness adjustment parameter with a previous brightness adjustment parameter array of a brightness automatic adjustment function constructed previously, to constitute a new brightness adjustment parameter array, wherein the screen brightness value adjusted and a light sensation value of current ambient light are taken as the new brightness adjustment parameter;
reconstructing a new brightness automatic adjustment function with the new brightness adjustment parameter array; and
automatically adjusting the brightness on screen according to the new brightness automatic adjustment function, when the light sensation value of the current ambient light changes.

2. The method according to claim 1, wherein after the step of receiving a brightness adjustment instruction and adjusting a screen brightness value, the method further comprises:
determining whether the screen brightness value adjusted exceeds a first preset range of screen brightness values associated with the light sensation value of the current ambient light;
maintaining the screen brightness value adjusted, if the screen brightness value adjusted does not exceed the first preset range of screen brightness values;
issuing a prompt that the screen brightness value adjusted exceeds the first preset range of screen brightness values, and determining whether an instruction of changing a brightness value is received, if the screen brightness value adjusted exceeds the first preset range of screen brightness values; and
maintaining the screen brightness value adjusted, if the instruction of changing a brightness value is received.

3. The method according to claim 2, wherein after the step of determining whether an instruction of changing a brightness value is received, the method further comprises:
returning to and maintaining a previous automatic adjusted screen brightness value, if an instruction of not changing a brightness value is received; or
adjusting the screen brightness value to be a maximum value in the first preset range of screen brightness values, if the instruction of not changing a brightness value is received and the screen brightness value adjusted is greater than the maximum value in the first preset range of screen brightness values; and
adjusting the screen brightness value to be a minimum value in the first preset range of screen brightness values, if the instruction of not changing a brightness value is received and the screen brightness value adjusted is less than the minimum value in the first preset range of screen brightness values.

4. The method according to claim 2, wherein before the step of constituting a new brightness adjustment parameter array, the method further comprises:
determining whether the screen brightness value adjusted is less than a screen brightness value corresponding to a previous brightness adjustment parameter, of which a light sensation value is less than the light sensation value of the current ambient light in the previous brightness adjustment parameter array;
modifying screen brightness values corresponding to all of previous brightness adjustment parameters, of which light sensation values are less than the light sensation value of the current ambient light and screen brightness values are greater than the screen brightness value adjusted in the previous brightness adjustment parameter array, to be the screen brightness value adjusted, if the screen brightness value adjusted is less than the screen brightness value corresponding to the previous brightness adjustment parameter;
directly adding the screen brightness value adjusted and the light sensation value of the current ambient light as the new brightness adjustment parameter into the previous brightness adjustment parameter array, to constitute the new brightness adjustment parameter array, if the screen brightness value adjusted is not less than the screen brightness value corresponding to the previous brightness adjustment parameter; and/or
determining whether the screen brightness value adjusted is greater than a screen brightness value corresponding to a previous brightness adjustment parameter, of which a light sensation value is greater than the light sensation value of the current ambient light in the previous brightness adjustment parameter array;
modifying screen brightness values corresponding to all of previous brightness adjustment parameters, of which light sensation values are greater than the light sensation value of the current ambient light and screen brightness values are less than the screen brightness value adjusted in the previous brightness adjustment parameter array, to be the screen brightness value adjusted, if the screen brightness value adjusted is greater than the screen brightness value corresponding to the previous brightness adjustment parameter;
directly adding the screen brightness value adjusted and the light sensation value of the current ambient light as the new brightness adjustment parameter into the previous brightness adjustment parameter array, to constitute the new brightness adjustment parameter array, if the screen brightness value adjusted is not greater than the screen brightness value corresponding to the previous brightness adjustment parameter.

5. The method according to claim 1, wherein before the step of constituting a new brightness adjustment parameter array, the method further comprises:
determining whether the screen brightness value adjusted exceeds a second preset range of screen brightness values associated with the light sensation value of the current ambient light;
determining that the screen brightness value adjusted is pseudo data, excluding the pseudo data from the new brightness adjustment parameter array, and returning to and maintaining a previous automatic adjusted screen brightness value, if the screen brightness value adjusted exceeds the second preset range of screen brightness values; and
directly adding the screen brightness value adjusted and the light sensation value of the current ambient light as the new brightness adjustment parameter into the previous brightness adjustment parameter array, to constitute the new brightness adjustment parameter array, if the screen brightness value adjusted does not exceed the second preset range of screen brightness values.

6. A non-volatile computer-readable storage medium storing computer executable instructions that, when executed by an electronic device, cause the electronic device to:
receive an instruction of adjusting brightness and adjust a screen brightness value;
combine a new brightness adjustment parameter with a previous brightness adjustment parameter array of a brightness automatic adjustment function constructed previously, to constitute a new brightness adjustment parameter array, wherein the screen brightness value adjusted and a light sensation value of current ambient light are taken as the new brightness adjustment parameter;
reconstruct a new brightness automatic adjustment function with the new brightness adjustment parameter array; and
automatically adjust the brightness on screen according to the new brightness automatic adjustment function, when the light sensation value of the current ambient light changes.

7. The non-volatile computer-readable storage medium according to claim 6, wherein after the step of receiving a brightness adjustment instruction and adjusting a screen brightness value, the electronic device is further caused to:
determine whether the screen brightness value adjusted exceeds a first preset range of screen brightness values associated with the light sensation value of the current ambient light;
maintain the screen brightness value adjusted, if the screen brightness value adjusted does not exceed the first preset range of screen brightness values;
issue a prompt that the screen brightness value adjusted exceeds the first preset range of screen brightness values, and determine whether an instruction of changing a brightness value is received, if the screen brightness value adjusted exceeds the first preset range of screen brightness values; and
maintain the screen brightness value adjusted, if the instruction of changing a brightness value is received.

8. The non-volatile computer-readable storage medium according to claim 7, wherein after the step of determining whether an instruction of changing a brightness value is received, the electronic device is further caused to:
return to and maintain a previous automatic adjusted screen brightness value, if an instruction of not changing a brightness value is received; or
adjust the screen brightness value to be a maximum value in the first preset range of screen brightness values, if the instruction of not changing a brightness value is received and the screen brightness value adjusted is greater than the maximum value in the first preset range of screen brightness values; and
adjust the screen brightness value to be a minimum value in the first preset range of screen brightness values, if the instruction of not changing a brightness value is received and the screen brightness value adjusted is less than the minimum value in the first preset range of screen brightness values.

9. The non-volatile computer-readable storage medium according to 8, wherein before the step of constituting a new brightness adjustment parameter array, the electronic device is further caused to:
determine whether the screen brightness value adjusted is less than a screen brightness value corresponding to a previous brightness adjustment parameter, of which a light sensation value is less than the light sensation value of the current ambient light in the previous brightness adjustment parameter array;
modify screen brightness values corresponding to all of previous brightness adjustment parameters, of which light sensation values are less than the light sensation value of the current ambient light and screen brightness values are greater than the screen brightness value adjusted in the previous brightness adjustment parameter array, to be the screen brightness value adjusted, if the screen brightness value adjusted is less than the screen brightness value corresponding to the previous brightness adjustment parameter;
directly add the screen brightness value adjusted and the light sensation value of the current ambient light as the new brightness adjustment parameter into the previous brightness adjustment parameter array, to constitute the new brightness adjustment parameter array, if the screen brightness value adjusted is not less than the screen brightness value corresponding to the previous brightness adjustment parameter; and/or
determine whether the screen brightness value adjusted is greater than a screen brightness value corresponding to a previous brightness adjustment parameter, of which a light sensation value is greater than the light sensation value of the current ambient light in the previous brightness adjustment parameter array;
modify screen brightness values corresponding to all of previous brightness adjustment parameters, of which light sensation values are greater than the light sensation value of the current ambient light and screen brightness values are less than the screen brightness value adjusted in the previous brightness adjustment parameter array, to be the screen brightness value adjusted, if the screen brightness value adjusted is greater than the screen brightness value corresponding to the previous brightness adjustment parameter;
directly add the screen brightness value adjusted and the light sensation value of the current ambient light as the new brightness adjustment parameter into the previous brightness adjustment parameter array, to constitute the new brightness adjustment parameter array, if the screen brightness value adjusted is not greater than the screen brightness value corresponding to the previous brightness adjustment parameter.

10. The non-volatile computer-readable storage medium according to claim 6, wherein before the step of constituting a new brightness adjustment parameter array, the electronic device is further caused to:
determine whether the screen brightness value adjusted exceeds a second preset range of screen brightness values associated with the light sensation value of the current ambient light;
determine that the screen brightness value adjusted is pseudo data, exclude the pseudo data from the new brightness adjustment parameter array, and return to and maintain a previous automatic adjusted screen brightness value, if the screen brightness value adjusted exceeds the second preset range of screen brightness values; and
directly add the screen brightness value adjusted and the light sensation value of the current ambient light as the new brightness adjustment parameter into the previous brightness adjustment parameter array, to constitute the new brightness adjustment parameter array, if the screen brightness value adjusted does not exceed the second preset range of screen brightness values.

11. An electronic device, comprising:
at least one processor; and
a memory communicably connected with the at least one processor,
wherein the memory is stored with instructions executable by the at least one processor, and the instructions are executed by the at least one processor to cause the at least one processor to:
receive an instruction of adjusting brightness and adjust a screen brightness value;
combine a new brightness adjustment parameter with a previous brightness adjustment parameter array of a brightness automatic adjustment function constructed previously, to constitute a new brightness adjustment parameter array, wherein the screen brightness value adjusted and a light sensation value of current ambient light are taken as the new brightness adjustment parameter;
reconstruct a new brightness automatic adjustment function with the new brightness adjustment parameter array; and
automatically adjust the brightness on screen according to the new brightness automatic adjustment function, when the light sensation value of the current ambient light changes.

12. The electronic device according to claim 11, wherein after the step of receiving a brightness adjustment instruction and adjusting a screen brightness value, the at least one processor is further caused to:
determine whether the screen brightness value adjusted exceeds a first preset range of screen brightness values associated with the light sensation value of the current ambient light;
maintain the screen brightness value adjusted, if the screen brightness value adjusted does not exceed the first preset range of screen brightness values;
issue a prompt that the screen brightness value adjusted exceeds the first preset range of screen brightness values, and determine whether an instruction of changing a brightness value is received, if the screen brightness value adjusted exceeds the first preset range of screen brightness values; and
maintain the screen brightness value adjusted, if the instruction of changing a brightness value is received.

13. The electronic device according to claim 12 wherein after the step of determining whether an instruction of changing a brightness value is received, the at least one processor is further caused to:
return to and maintain a previous automatic adjusted screen brightness value, if an instruction of not changing a brightness value is received; or
adjust the screen brightness value to be a maximum value in the first preset range of screen brightness values, if the instruction of not changing a brightness value is received and the screen brightness value adjusted is greater than the maximum value in the first preset range of screen brightness values; and
adjust the screen brightness value to be a minimum value in the first preset range of screen brightness values, if the instruction of not changing a brightness value is received and the screen brightness value adjusted is less than the minimum value in the first preset range of screen brightness values.

14. The electronic device according to claim 12, wherein before the step of constituting a new brightness adjustment parameter array, the at least one processor is further caused to:
determine whether the screen brightness value adjusted is less than a screen brightness value corresponding to a previous brightness adjustment parameter, of which a light sensation value is less than the light sensation value of the current ambient light in the previous brightness adjustment parameter array;
modify screen brightness values corresponding to all of previous brightness adjustment parameters, of which light sensation values are less than the light sensation value of the current ambient light and screen brightness values are greater than the screen brightness value adjusted in the previous brightness adjustment parameter array, to be the screen brightness value adjusted, if the screen brightness value adjusted is less than the screen brightness value corresponding to the previous brightness adjustment parameter;
directly add the screen brightness value adjusted and the light sensation value of the current ambient light as the new brightness adjustment parameter into the previous brightness adjustment parameter array, to constitute the new brightness adjustment parameter array, if the screen brightness value adjusted is not less than the screen brightness value corresponding to the previous brightness adjustment parameter; and/or
determine whether the screen brightness value adjusted is greater than a screen brightness value corresponding to a previous brightness adjustment parameter, of which a light sensation value is greater than the light sensation value of the current ambient light in the previous brightness adjustment parameter array;
modify screen brightness values corresponding to all of previous brightness adjustment parameters, of which light sensation values are greater than the light sensation value of the current ambient light and screen brightness values are less than the screen brightness value adjusted in the previous brightness adjustment parameter array, to be the screen brightness value adjusted, if the screen brightness value adjusted is greater than the screen brightness value corresponding to the previous brightness adjustment parameter;
directly add the screen brightness value adjusted and the light sensation value of the current ambient light as the new brightness adjustment parameter into the previous brightness adjustment parameter array, to constitute the new brightness adjustment parameter array, if the screen brightness value adjusted is not greater than the screen brightness value corresponding to the previous brightness adjustment parameter.

15. The electronic device according to claim 11, wherein before the step of constituting a new brightness adjustment parameter array, the at least one processor is further caused to:
determine whether the screen brightness value adjusted exceeds a second preset range of screen brightness values associated with the light sensation value of the current ambient light;
determine that the screen brightness value adjusted is pseudo data, exclude the pseudo data from the new brightness adjustment parameter array, and return to and maintain a previous automatic adjusted screen brightness value, if the screen brightness value adjusted exceeds the second preset range of screen brightness values; and
directly add the screen brightness value adjusted and the light sensation value of the current ambient light as the new brightness adjustment parameter into the previous brightness adjustment parameter array, to constitute the new brightness adjustment parameter array, if the screen brightness value adjusted does not exceed the second preset range of screen brightness values.

16. The method according to claim 3 wherein before the step of constituting a new brightness adjustment parameter array, the method further comprises:
determining whether the screen brightness value adjusted is less than a screen brightness value corresponding to a previous brightness adjustment parameter, of which a light sensation value is less than the light sensation value of the current ambient light in the previous brightness adjustment parameter array;
modifying screen brightness values corresponding to all of previous brightness adjustment parameters, of which light sensation values are less than the light sensation value of the current ambient light and screen brightness values are greater than the screen brightness value adjusted in the previous brightness adjustment parameter array, to be the screen brightness value adjusted, if the screen brightness value adjusted is less than the screen brightness value corresponding to the previous brightness adjustment parameter;
directly adding the screen brightness value adjusted and the light sensation value of the current ambient light as the new brightness adjustment parameter into the previous brightness adjustment parameter array, to constitute the new brightness adjustment parameter array, if the screen brightness value adjusted is not less than the screen brightness value corresponding to the previous brightness adjustment parameter; and/or
determining whether the screen brightness value adjusted is greater than a screen brightness value corresponding to a previous brightness adjustment parameter, of which a light sensation value is greater than the light sensation value of the current ambient light in the previous brightness adjustment parameter array;
modifying screen brightness values corresponding to all of previous brightness adjustment parameters, of which light sensation values are greater than the light sensation value of the current ambient light and screen brightness values are less than the screen brightness value adjusted in the previous brightness adjustment parameter array, to be the screen brightness value adjusted, if the screen brightness value adjusted is greater than the screen brightness value corresponding to the previous brightness adjustment parameter;
directly adding the screen brightness value adjusted and the light sensation value of the current ambient light as the new brightness adjustment parameter into the previous brightness adjustment parameter array, to constitute the new brightness adjustment parameter array, if the screen brightness value adjusted is not greater than the screen brightness value corresponding to the previous brightness adjustment parameter.

17. The non-volatile computer-readable storage medium according to claim 7, wherein before the step of constituting a new brightness adjustment parameter array, the electronic device is further caused to:
determine whether the screen brightness value adjusted is less than a screen brightness value corresponding to a previous brightness adjustment parameter, of which a light sensation value is less than the light sensation value of the current ambient light in the previous brightness adjustment parameter array;
modify screen brightness values corresponding to all of previous brightness adjustment parameters, of which light sensation values are less than the light sensation value of the current ambient light and screen brightness values are greater than the screen brightness value adjusted in the previous brightness adjustment parameter array, to be the screen brightness value adjusted, if the screen brightness value adjusted is less than the screen brightness value corresponding to the previous brightness adjustment parameter;
directly add the screen brightness value adjusted and the light sensation value of the current ambient light as the new brightness adjustment parameter into the previous brightness adjustment parameter array, to constitute the new brightness adjustment parameter array, if the screen brightness value adjusted is not less than the screen brightness value corresponding to the previous brightness adjustment parameter; and/or
determine whether the screen brightness value adjusted is greater than a screen brightness value corresponding to a previous brightness adjustment parameter, of which a light sensation value is greater than the light sensation value of the current ambient light in the previous brightness adjustment parameter array;
modify screen brightness values corresponding to all of previous brightness adjustment parameters, of which light sensation values are greater than the light sensation value of the current ambient light and screen brightness values are less than the screen brightness value adjusted in the previous brightness adjustment parameter array, to be the screen brightness value adjusted, if the screen brightness value adjusted is greater than the screen brightness value corresponding to the previous brightness adjustment parameter;
directly add the screen brightness value adjusted and the light sensation value of the current ambient light as the new brightness adjustment parameter into the previous brightness adjustment parameter array, to constitute the new brightness adjustment parameter array, if the screen brightness value adjusted is not greater than the screen brightness value corresponding to the previous brightness adjustment parameter.

18. The non-volatile computer-readable storage medium according to claim 8, wherein before the step of constituting a new brightness adjustment parameter array, the electronic device is further caused to:
determine whether the screen brightness value adjusted is less than a screen brightness value corresponding to a previous brightness adjustment parameter, of which a light sensation value is less than the light sensation value of the current ambient light in the previous brightness adjustment parameter array;
modify screen brightness values corresponding to all of previous brightness adjustment parameters, of which light sensation values are less than the light sensation value of the current ambient light and screen brightness values are greater than the screen brightness value adjusted in the previous brightness adjustment parameter array, to be the screen brightness value adjusted, if the screen brightness value adjusted is less than the screen brightness value corresponding to the previous brightness adjustment parameter;
directly add the screen brightness value adjusted and the light sensation value of the current ambient light as the new brightness adjustment parameter into the previous brightness adjustment parameter array, to constitute the new brightness adjustment parameter array, if the screen brightness value adjusted is not less than the screen brightness value corresponding to the previous brightness adjustment parameter; and/or
determine whether the screen brightness value adjusted is greater than a screen brightness value corresponding to a previous brightness adjustment parameter, of which a light sensation value is greater than the light sensation value of the current ambient light in the previous brightness adjustment parameter array;
modify screen brightness values corresponding to all of previous brightness adjustment parameters, of which light sensation values are greater than the light sensation value of the current ambient light and screen brightness values are less than the screen brightness value adjusted in the previous brightness adjustment parameter array, to be the screen brightness value adjusted, if the screen brightness value adjusted is greater than the screen brightness value corresponding to the previous brightness adjustment parameter;
directly add the screen brightness value adjusted and the light sensation value of the current ambient light as the new brightness adjustment parameter into the previous brightness adjustment parameter array, to constitute the new brightness adjustment parameter array, if the screen brightness value adjusted is not greater than the screen brightness value corresponding to the previous brightness adjustment parameter.

19. The electronic device according to claim 13, wherein before the step of constituting a new brightness adjustment parameter array, the at least one processor is further caused to:
determine whether the screen brightness value adjusted is less than a screen brightness value corresponding to a previous brightness adjustment parameter, of which a light sensation value is less than the light sensation value of the current ambient light in the previous brightness adjustment parameter array;
modify screen brightness values corresponding to all of previous brightness adjustment parameters, of which light sensation values are less than the light sensation value of the current ambient light and screen brightness values are greater than the screen brightness value adjusted in the previous brightness adjustment parameter array, to be the screen brightness value adjusted, if the screen brightness value adjusted is less than the screen brightness value corresponding to the previous brightness adjustment parameter;
directly add the screen brightness value adjusted and the light sensation value of the current ambient light as the new brightness adjustment parameter into the previous brightness adjustment parameter array, to constitute the new brightness adjustment parameter array, if the screen brightness value adjusted is not less than the screen brightness value corresponding to the previous brightness adjustment parameter; and/or
determine whether the screen brightness value adjusted is greater than a screen brightness value corresponding to a previous brightness adjustment parameter, of which a light sensation value is greater than the light sensation value of the current ambient light in the previous brightness adjustment parameter array;
modify screen brightness values corresponding to all of previous brightness adjustment parameters, of which light sensation values are greater than the light sensation value of the current ambient light and screen brightness values are less than the screen brightness value adjusted in the previous brightness adjustment parameter array, to be the screen brightness value adjusted, if the screen brightness value adjusted is greater than the screen brightness value corresponding to the previous brightness adjustment parameter;
directly add the screen brightness value adjusted and the light sensation value of the current ambient light as the new brightness adjustment parameter into the previous brightness adjustment parameter array, to constitute the new brightness adjustment parameter array, if the screen brightness value adjusted is not greater than the screen brightness value corresponding to the previous brightness adjustment parameter.

20. The method according to claim 2, wherein before the step of constituting a new brightness adjustment parameter array, the method further comprises:
determining whether the screen brightness value adjusted exceeds a second preset range of screen brightness values associated with the light sensation value of the current ambient light;
determining that the screen brightness value adjusted is pseudo data, excluding the pseudo data from the new brightness adjustment parameter array, and returning to and maintaining a previous automatic adjusted screen brightness value, if the screen brightness value adjusted exceeds the second preset range of screen brightness values; and
directly adding the screen brightness value adjusted and the light sensation value of the current ambient light as the new brightness adjustment parameter into the previous brightness adjustment parameter array, to constitute the new brightness adjustment parameter array, if the screen brightness value adjusted does not exceed the second preset range of screen brightness values.
